(19) United States
(12) Patent Application Publication
(10) Pub. No.: US 2004/0005535 A1
(43) Pub. Date: Jan. 8, 2004

(54) Process of reincarnation

(76) Inventor: George Knauer III, Naples, FL (US)

Correspondence Address: Merrill N. Johnson, 800 Harbour Drive, Naples, FL, 34103, US

(21) Appl. No.: 10/035,947

(22) Filed: Jul. 8, 2002

(51) Int. Cl. G09B 23/06

(52) U.S. Cl. 434/300

(57) ABSTRACT

The invention consists of the process of reincarnation or rebirth resulting in immortality.

### SUMMARY OF THE INVENTION

This invention resulted from my combining Einstein's Theory of Relativity and Newton's Second Law of Physics.

Reincarnation is defined in Webster's Third New Inernational Dictionary as “rebith”. Thus my invention is a process of rebirth or in other words immortality.

I claim:

1. The process of reincarnation or rebirth which results in immortality.
